(19) United States
(12) Patent Application Publication
(10) Pub. No.: US 2025/0370311 A1
(43) Pub. Date: Dec. 4, 2025

(54) Combined Variable Aperture and Shutter Device for Camera

(71) Applicant: Apple Inc., Cupertino, CA (US)

(72) Inventors: Bin Xu, Sunnyvale, CA (US); Aurelien R Hubert, Saratoga, CA (US); Wei Li, Sunnyvale, CA (US); Xu Wang, San Jose, CA (US)

(73) Assignee: Apple Inc., Cupertino, CA (US)

(21) Appl. No.: 19/215,169

(22) Filed: May 21, 2025

Related U.S. Application Data
(60) Provisional application No. 63/654,875, filed on May 31, 2024.

(51) Int. Cl. G03B 9/06; G03B 7/00; G03B 9/14; G03B 17/12; G03B 30/00

(52) U.S. Cl. CPC G03B 9/06; G03B 7/003; G03B 9/14; G03B 17/12; G03B 30/00

(57) ABSTRACT

Various embodiments include a combined variable aperture and shutter device for a camera system. The combined variable aperture and shutter device may be coupled with a lens assembly of the camera system. The combined variable aperture and shutter device may include one for more sets of blades arranged to provide a variable aperture as well as a shutter with a reduced stack height. For example, a single set of blades may be shaped such that rotation of the set of blades moves the blades between a fully open state, a mid-state and a shutter state. In another example, one set of blades may provide various aperture sizes while a second set of blades provide shutter functionality.

### PRIORITY CLAIM

This application claims benefit of priority to U.S. Provisional Application Ser. No. 63/654,875, entitled “Combined Variable Aperture And Shutter Device for Camera,” filed May 31, 2024, and which is hereby incorporated herein by reference in its entirety.

### BACKGROUND

### Technical Field

This disclosure relates generally to a combined variable aperture and shutter device for a camera.

### Description of the Related Art

The advent of small, mobile multipurpose devices such as smartphones and tablet or pad devices has resulted in a need for high-resolution, small form factor cameras for integration in the devices. Some small form factor cameras may incorporate optical image stabilization (OIS) mechanisms that may sense and react to external excitation/disturbance by adjusting location of the optical lens on the X and/or Y axis in an attempt to compensate for unwanted motion of the lens. Some small form factor cameras may incorporate an autofocus (AF) mechanism whereby the object focal distance can be adjusted to focus an object plane in front of the camera at an image plane to be captured by the image sensor. In some such autofocus mechanisms, the optical lens is moved as a single rigid body along the optical axis of the camera to refocus the camera. Some such small form factor cameras may incorporate a number of blades (e.g., aperture blades or others) contributing to a tall stack height, adding to an overall z-height of the camera.

### BRIEF DESCRIPTION OF THE DRAWINGS

FIG. 1A illustrates a schematic side cross-sectional view of an example camera system that may include a combined variable aperture and shutter device, in accordance with some embodiments.

FIGS. 1B and 1C illustrate a view of blades in an example combined variable aperture and shutter device housing, in accordance with some embodiments.

FIGS. 2A-2C illustrate views of various states (open, mid, shutter) of blades of an example coupled variable aperture and shutter device, and corresponding aperture states (open, mid, shuttered) that may be included in a camera system, in accordance with some embodiments.

FIGS. 3A-3C illustrate views of various states (open, mid, shutter) of an example de-coupled variable aperture and shutter device that may be included in a camera system, in accordance with some embodiments.

FIGS. 4A-4B illustrate views of individual components of a combined variable aperture and shutter device, in accordance with some embodiments.

FIGS. 5A-5C illustrate views of individual components of blades of a de-coupled variable aperture and shutter device, in accordance with some embodiments.

FIGS. 6A-6D illustrate views of various combinations of blades in an example de-coupled variable aperture and shutter device that may be included in a camera system, in accordance with some embodiments.

FIGS. 7A-7B illustrate views of the example combined de-coupled variable aperture and shutter device blades in FIGS. 6A-6D within a variable aperture shutter device housing, in accordance with some embodiments.

FIG. 8 illustrates a schematic representation of an example environment comprising a device that may include a camera with a combined variable aperture and shutter device, in accordance with some embodiments.

FIG. 9 illustrates a schematic block diagram of an example environment comprising a computer system that may include a camera with a combined variable aperture and shutter device, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments include combinations of components for a combined variable aperture and shutter device for a camera. The combined variable aperture and shutter device may be coupled with a lens assembly of a camera, for example. The lens assembly may include a lens group contained within a lens barrel. In various embodiments, the combined variable aperture and shutter device may sit atop a portion of the lens assembly. Aspects of the combined variable aperture and shutter device described herein solve problems that may exist in other camera systems, such as problems pertaining to camera/device size, weight, and/or performance, as will be discussed in further detail throughout this disclosure.

For example, various arrangements of blades for variable apertures are unable to achieve a shutter function (e.g., because the blades may interfere with each other before full closure, such as but not limited to a two-layer blade layout with three blades on top and 3 blades on bottom) or have an undesirable stack height (e.g., such as but not limited to a six layer blade layout that may achieve full closure but has a large Z stack-up height as there are six layers). At least some embodiments herein may achieve a combination of variable aperture states and a closed shutter state in 3 layers or less, reducing stack height.

According to various embodiments, the combined variable aperture and shutter device may be configured to provide various combinations of a variable aperture and shutter for the lens group and/or the camera system. Some embodiments may achieve the combined variable aperture and shutter with a reduced stack-up height (reducing height in a z-direction).

In some embodiments, the combined variable aperture and shutter device may include a stator, a rotor, aperture blades and/or shutter blades and one or more actuators. The aperture blades may be arranged to form an aperture stop and a shutter, or there may be separate blades that provide the shutter, in embodiments (e.g., a de-coupled architecture). The actuator may be used for moving the aperture blades and/or the shutter blades to change the size of the aperture within a range of aperture sizes and/or actuate the shutter blades. The aperture stop may function to limit the amount of light that reaches the lens group via the aperture. A shutter may function to control a length of time that light is permitted to pass through the lens to the image sensor. The shutter may function to control the perception of movement, in embodiments.

In some embodiments, a device (e.g., a consumer electronics device, such as but not limited to a smartphone) includes processor(s) and memory that stores executable program instructions that control operations of a camera of the device. The camera may include a lens group of one or more lens elements that define an optical axis, and a variable aperture mechanism. The variable aperture mechanism may include one or more sets of blades, and one or more actuators configured to move the one or more sets of blades to vary an aperture for the camera between at least three states of the one or more sets of blades, the three states including at least two differently-sized open states and a fully shuttered state. In some embodiments, the one or more sets of blades are shaped to move between the at least three states with no more than three levels of overlap of the one or more sets of blades.

In various embodiments, the variable aperture mechanism may include a rotor/stator type of actuator assembly. An actuator may rotate the rotor, relative to the stator, about an axis that is parallel to the optical axis. The actuator may include a first portion fixedly coupled with the rotor wall, and a second portion fixedly coupled with an outer protrusion portion of the stator. The aperture blades may be coupled with the stator and the rotor. Rotation of the rotor may cause the aperture blades to move so as to change the size of the aperture.

In some embodiments, the actuator may include a voice coil motor (VCM) actuator having one or more magnets and one or more coils. The coil(s) may be positioned proximate the magnet(s) such that, when driven with an electric current, the coil(s) are capable of electromagnetically interacting with the magnet(s) to produce Lorentz forces that rotate the rotor about the axis parallel to the optical axis. In some embodiments, the magnet(s) may be fixedly coupled with the rotor wall, and the coil(s) may be fixedly coupled with the outer protrusion portion of the stator. In other embodiments, the coil(s) may be fixedly coupled with the rotor wall, and the magnet(s) may be fixedly coupled with the outer protrusion portion of the stator.

In various embodiments, the combined variable aperture and shutter device may include a flex circuit. The flex circuit may be coupled with the stator. In various embodiments, the flex circuit may be a single-piece flex circuit that is attached to the base portion of the stator.

According to various embodiments, the combined variable aperture and shutter device may include a shield can that at least partially encases the combined variable aperture and shutter device. For example, an aluminum shield can may at least partially encase the VCM actuator.

In some embodiments, the aluminum shield can and/or the aperture blades and/or the shutter blades may be coated with a black material that reduces the reflectivity of the aluminum shield can and blades. In some examples, the material used to coat the aluminum shield can and/or the aperture blades may be a “super-black” or an “ultra-black” coating that offer a greater reduction in reflectivity than materials used in some other systems.

In some embodiments, the aperture blades may be designed so that they form a circular aperture at a particular aperture size. The circular aperture may be a close approximation of a circular shape, e.g., approaching the shape of a circle rather than a polygon. As compared with variable aperture designs of some other systems, the circular aperture may be closer to a circular shape and those other systems may have apertures having shapes that appear more polygonal (e.g., hexagonal) than circular across the entire range of aperture sizes.

In some non-limiting embodiments, the particular aperture size at which the aperture blades are designed to form a circular shape may be an aperture size that is between the largest aperture size and the smallest aperture size within the range of aperture sizes that the combined variable aperture and shutter device is capable of forming. For example, the particular aperture size at which the aperture blades are optimized to form a circular shape may be a middle/intermediate aperture size within the range of aperture sizes in some embodiments.

Various parameters may be optimized to achieve this objective. For example, such parameters may include shape and/or size of the aperture blades, coupling slots defined by the aperture blades, and/or coupling pin holes defined by the aperture blades, as well as the geometry of the stator, the rotor, pins (sometimes referred to as pivots, herein) on the stator and the rotor with which the aperture blades may be coupled (e.g., via the coupling slots and the coupling pin holes), etc. In various embodiments, the aperture blades may be shaped to have an inner edge with a curvature, e.g., as indicated in various figures of this disclosure.

Designing the aperture blades so that they form a circular aperture at a particular aperture size solves problem(s) of how to reduce unintended flare, aberrations, and/or diffraction, etc., in images captured using the camera system. Thus, the aperture blade design in the combined variable aperture and shutter device disclosed herein may enable various improvements in optical performance and/or image quality.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

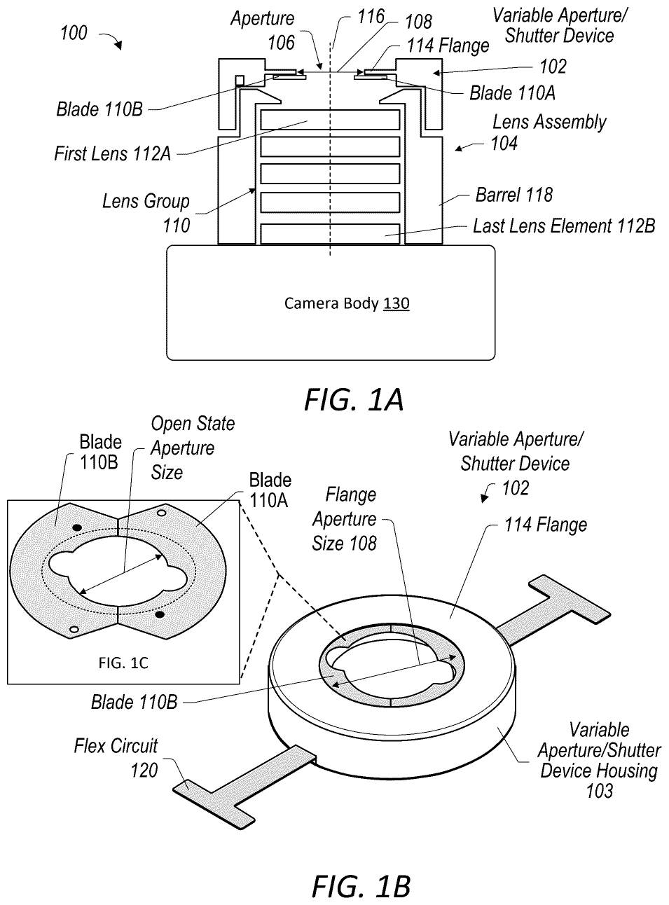

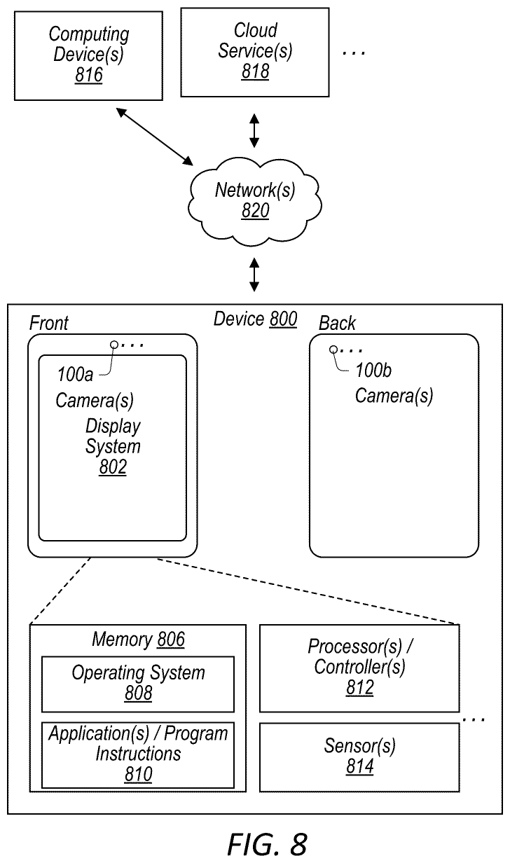

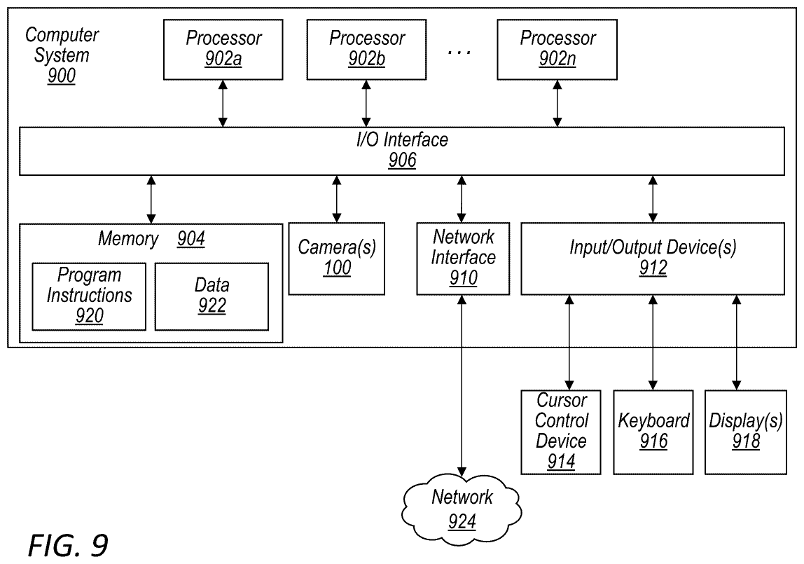

FIG. 1A illustrates a schematic side cross-sectional view of an example camera system that may include a combined variable aperture and shutter device, in accordance with some embodiments. Related FIGS. 1B/C, 2A-C, 3A-C, 4A-B, 5A-C, 6A-D, and 7A-B illustrate views of various components of a combined variable aperture and shutter device, in accordance with some embodiments. FIG. 8 illustrates a device (e.g., a multifunction devices such as but not limited to a consumer electronics device) that include(s) one or more cameras, at least one of which may include a combined variable aperture and shutter device, in accordance with some embodiments. FIG. 9 illustrates a computer system that may be part of the device illustrated in FIG. 8, for example.

As will be discussed in further detail herein with reference to FIGS. 1A-8, the combined variable aperture and shutter device may be configured to provide a variable aperture for the lens assembly 104 and/or the camera system 100.

FIG. 1A illustrates a combined variable aperture and shutter device 102 that include blades (e.g., blades 110A/B in FIGS. 1B/1C) arranged to form an aperture stop, and an actuator for moving the aperture blades to change the size of the aperture within a range of aperture sizes. FIG. 1A shows a flange 114 next to an example aperture 106 having an aperture size 108, which may be changed to a different size via an actuator. Also illustrated are blades 110A 110B, a lens group 110 including a first lens 112A and last lens element 112B within barrel 118, and an optical axis 116. That entire assembly is illustrated atop camera body 130, which may include an image sensor and other related components, in embodiments.

In various embodiments, the lens assembly 104 may include a lens group having one or more lens elements 112 that define an optical axis 116. The aperture stop may function to limit the amount of light that reaches the lens group via the aperture 106. Further, in some embodiments, the lens assembly 104 may include a lens barrel 118 that contains the lens element(s) 112, e.g., as indicated in FIG. 1A. According to some non-limiting embodiments, the combined variable aperture and shutter device 100 may be coupled with an upper portion of the lens barrel 118. The example lens group 110 shown in FIG. 1A includes multiple stacked lens elements 112, including a “first” lens element 112A and a “last” lens element 112B. The first lens element 112A may be the lens element nearest an object side of the lens assembly 104, and the last lens element 112B may be the lens element nearest an image side of the lens assembly 104. The combined variable aperture and shutter device 100 may be positioned proximate the first lens element 112A, e.g., such that the aperture stop is located, in a direction parallel to the optical axis, between the first lens element 112A and an object (e.g., a subject of an image to be captured using the camera system 100). Additionally, or alternatively, the combined variable aperture and shutter device 100 may be positioned such that the aperture 106 is aligned with the optical axis 116, e.g., as indicated in FIG. 1A. For example, the optical axis 116 may intersect the aperture 106 and/or be coincident with a central axis of the combined variable aperture and shutter device 100.

Although not shown in FIGS. 1A-1C, it should be understood that the camera system 100 may include various other components, such as, but not limited to, an image sensor, one or more actuators (e.g., an autofocus (AF) actuator and/or an optical image stabilization (OIS) actuator), and/or a suspension arrangement, etc. In some embodiments, the camera system 100 may be configured such that light passes through the aperture 106 and the lens group 110 before reaching the image sensor. An image plane defined by the image sensor may be orthogonal to the optical axis 116 in some embodiments. In other embodiments, camera system 100 may include a folded optics arrangement configured to redirect the light, and the image plane may be parallel to the optical axis 116 indicated in FIG. 1A or otherwise suitably oriented.

In some embodiments, the actuator(s) may include an AF actuator and/or an OIS actuator for moving the lens group 110 relative to the image sensor. Additionally, or alternatively, the actuator(s) may include an AF actuator and/or an OIS actuator for moving the image sensor relative to the lens group 110.

The aperture blades 110A 110B may be arranged to form an aperture stop. The combined variable aperture and shutter device 100 may include one or more actuators (e.g., a voice coil motor (VCM) actuator) for moving the aperture stop and/or shutter blades to change the size of the aperture defined by the aperture stop and/or to actuate the shutter. The aperture stop may function to limit the amount of light that reaches a lens group (e.g., lens group 110 in FIG. 1A) via the aperture.

According to various embodiments, the aperture blades (e.g., 110A 110B) may define one or more coupling features that allow the aperture blades to be coupled with one or more other components of the combined variable aperture and shutter device 100. In some examples, each of the aperture blades 110A 110B may define a respective slot and a respective pin hole. The slots may couple with pins (sometimes referred to as pivots, herein) of a rotor, and the pin holes may couple with pins (sometimes referred to as pivots, herein) of a stator. The rotor may rotate relative to the stator, causing the pins of the rotor to move within the slots 212. The shape of the aperture blades 110A 110B and the shape of the slots, among other things, may at least partially dictate the shape and/or size of the resulting aperture at a given position of the rotor relative to the stator.

FIG. 1B illustrates a view of blades in an example combined variable aperture and shutter device housing, in accordance with some embodiments. Blades 110A 110B are illustrated within an outer housing 103 of variable aperture/shutter device 102 that is coupled to flex circuit 120.

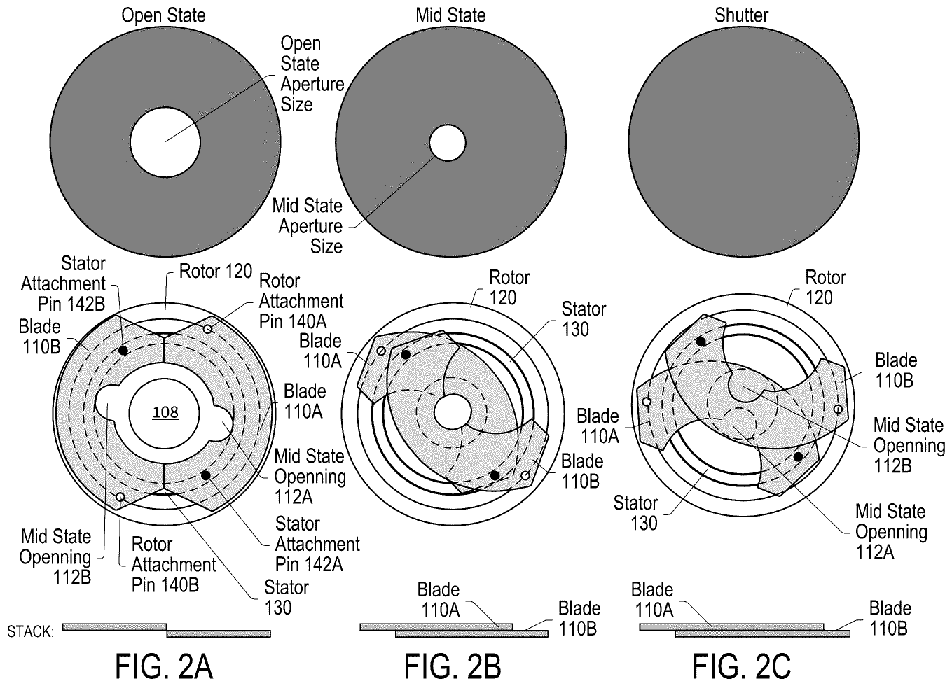

In various embodiments, the flex circuit 120 may route/convey electrical signals (e.g., power/drive signals, sensor signals, etc.) between components within the combined variable aperture and shutter device 102 and/or between the combined variable aperture and shutter device 120 and one or more other components of the camera. For example, at least a portion of the flex circuit 120 may be coupled with a stator (e.g., illustrated in FIGS. 2A-2C, described below) that provides for movement of the blades. For example, the flex circuit 120 may include a first portion that is fixedly coupled with the stator. Furthermore, the flex circuit 120 may include a second portion comprising one or more arms extending from the first portion away from the stator. In various embodiments, the flex circuit 120, including the first portion and the second portion, may be part of a single-piece flex circuit, or may be designed as multiple flex circuits that are coupled with one another.

The variable aperture/shutter device 102 is illustrated with a flange 114 having a flange aperture of a size 108 that is larger than an opening formed by the blades 110A/110B such that a portion of the blades are exposed through the flange aperture size 108. It is contemplated that in at least some embodiments the flange 114 may have an opening size that is smaller than the opening formed by the blades 110A/110B such that the blades are not exposed through the flange aperture size 108. For example, in FIG. 2A, a diameter of an aperture for a fully open state of the at least two differently-sized open aperture states is not determined by any of the blades; it is instead determined by the hole illustrated in the center of the rotor/stator device (e.g., an aperture-defining feature of the camera such as but not limited to a flange aperture, a camera lens aperture, or the like).

FIG. 1C illustrates blades 110A 110B arranged substantially as mirror images of one another. Substantially mirror images may indicate that the blades themselves are not actually formed as mirror images as inner cutouts for a mid-state (illustrated in FIG. 2B, described below) may be askew, as in FIG. 1C, while an outer shape or form of the blades 110A/110B may be the same for the blades, if each blade were rotated 180 degrees. For example, in some embodiments, blades 110A 110B may be formed of a same shape when manufactured, but arranged with regard to each other in variable aperture/shutter device 102 such that opposite ends are touching (as illustrated in FIG. 1C.

FIGS. 2A-2C illustrate views of various states (open, mid, shutter) of blades of an example coupled variable aperture and shutter device, and corresponding aperture states (open, mid, shuttered) that may be included in a camera system, in accordance with some embodiments.

According to various embodiments, the combined variable aperture and shutter device 100 may include a stator 130, a rotor 120, aperture blades 110A 110B, an actuator (e.g., comprising one or more magnets and one or more coils), a suspension arrangement (e.g., a ball bearing suspension arrangement comprising ball bearings), a flex circuit 120, and/or a shield can (having flange 114).

According to various embodiments, the actuator may be configured to rotate the rotor, relative to the stator, about an axis. Rotation of the rotor may cause the aperture blades 110A 110B to move so as to change the size of the aperture (e.g., from the first state in FIG. 2A to the second state in FIG. 2B, to the shutter state in FIG. 2C, and vice-versa, etc.).

In various embodiments, the actuator may include a voice coil motor (VCM) actuator having magnet(s) and coil(s). The coil(s) may be positioned proximate the magnet(s) such that, when driven with an electric current, the coil(s) are capable of electromagnetically interacting with the magnet(s) to produce Lorentz forces that rotate the rotor about the axis.

The lower portions of FIGS. 2A-2C illustrate the relationship between blades 110A/110B in a stack formation via a side cross-sectional view. For example, in FIG. 2A the stack illustration shows that one blade is located above the other blade in a z-direction (allowing for the blades to rotate past one another into the mid state and shutter state illustrated in FIGS. 2B and 2C). The stack illustrated in FIG. 2A illustrates that blades 110A/110B are aligned with one another such that no light can pass through where the blades meet (at a blade interface). In some embodiments, it is contemplated that edges of the blades, where the blades meet, may be chamfered, beveled, or the like, to provide for a slight overlap along the edges where blades 110A 110B meet in in FIG. 2A, to prevent or restrict unwanted light from passing between where the two blades meet, for example, without adding to the stack height.

FIG. 2A illustrates an open state of variable aperture/shutter device 102 having an open state aperture size. The state is achieved via the illustrated rotational alignment of blades 110A 110B such that an open state aperture size is achieved. In the illustrated embodiment the open state aperture size (illustrated in the open state graphic at the top of FIG. 2A) is determined by the flange aperture size 108 of flange 114 (see. FIG. 1B, described above). It is contemplated that the size of the aperture in the illustrated open state may determined by the inner curve of the blades 110A;/110B, in some embodiments (e.g., when a flange aperture size is larger than the inner circular shape (not illustrated) formed by blades 110A/110B in the blade relationship illustrated in FIG. 2A). In some embodiments, the size of the aperture in the illustrated open state may determined by a feature other than the blades, such as but not limited to, the flange aperture size 108 (e.g., when a flange aperture size is smaller than the inner circular shape (illustrated in FIG. 2A) formed by blades 110A/110B in relationship as illustrated in FIG. 2A), a camera lens aperture, or the like.

FIG. 2A illustrates that blades 110A and 110B are attached to rotor 120 and stator 130 via rotor attachment pins 140A, 140B and stator attachment pins 142A, 142B. Blades 110A and 110B are attached via the attachment pins such that when the rotor 120 is actuated to rotate, blades 110A and 110B rotate with respect to one another about the aperture 106. For example, FIGS. 2BA and 2C illustrate mid state and shutter positions that are achieved by such movement (the rotation of the blades 110A 110B about the aperture 106). FIG. 2A illustrates that blades 110A 110B exhibit mid state openings 112A and 112B. While the mid state openings 112A and 112B are not aligned to create the mid state opening when the blades 110A/110B are in the relationship illustrated in FIG. 2A, FIG. 2B illustrates that mid state openings 112A and 112B come into relationship to form the mid state opening size illustrated at the top of FIG. 2B when rotated into the position illustrated in FIG. 2B (e.g. a mid state rotational position).

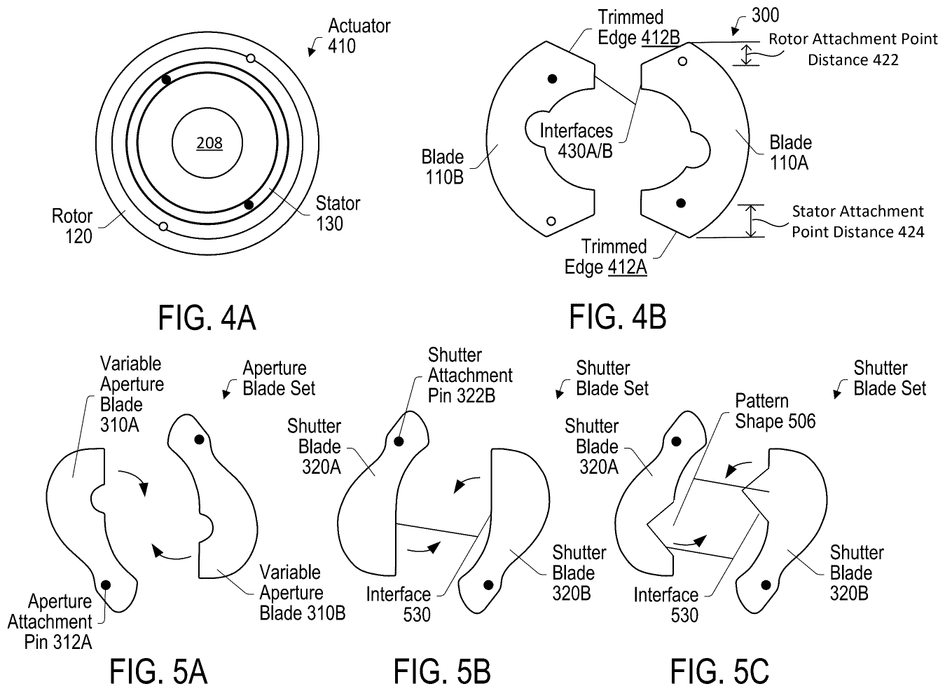

FIG. 2B illustrates that rotor attachment pins 140A, 140B and stator attachment pins 142A, 142B have rotated with the corresponding blades 110A, 110B into the mid state position such that the mid state openings 112A 112B form the mid state aperture size illustrated. In the illustrated embodiment, it is noticeable that rotor attachment pin 140A of blade 110A falls outside of the stator attachment pin 142A of blade 110A. Also, the outside edge of blade 110A extends out beyond the edge of blade 110A near-to stator attachment point 142A. These features illustrate the benefit of the trimmed outside edges of the blades (e.g., illustrated in FIG. 4B, described below) such that the blade can rotate without the rotation causing the outside edge of the blade to extend beyond the stator/rotor device sidewall (e.g., the outer circumference of the rotor 120), interfering with other components of the camera. Such a design may have the added benefit of eliminating contact with other components near-to but outside the circumference of the rotor 120 as the blades rotate through a range of intended motion, for example. At the bottom of FIG. 2B, a side view of the stack of blades 110A and 110B illustrates that the blades increase an amount of overlap in the mid state position.

FIG. 2C illustrates a shutter position of the blades achieved by rotation of the blades with respect to one another. In the illustrated position, the blades have a blade width sufficient to (in combination with one another) entirely cover the aperture 106. In the illustrated embodiment, even though a single blade is insufficient to act as a shutter alone (e.g., the mid-state opening of the blade would allow light to pass) when the blades are rotated into the illustrated relationship, each blade compensate for the deficiency of the other blade at the point where the mid state openings are formed, thereby forming a complete shutter in concert with one another. In FIG. 2C, the left side of blade 110A (near rotor attachment pin 140A) comes close to an outside edge of rotor 120, while the right side of blade 110A (near state attachment pin 142A) almost falls within the rotor 120. Such relationships illustrate how the blades move as they rotate about the aperture. The bottom of FIG. 2C illustrates the overlap of the stack of blades 110A 110B.

FIGS. 2A-2C illustrate a variable aperture mechanism for a camera, including one set of two blades that are actuatable by one or more actuators configured to move the set of blades to vary an aperture for the camera between three states of the set of blades, the three states including at least two differently-sized open states (e.g., open state in FIG. 2A, and mid state in FIG. 2B) and a fully shuttered state (shutter state in FIG. 2C). The illustrated set of blades are shaped to move between the three states with two levels that overlap one another as illustrated by the stack illustrations in FIGS. 2A-2C.

In embodiments, the set of two blades illustrated in FIGS. 2A-2C include no more than a single set of two blades and each individual blade of the single set of two blades includes a first inner curvature (forming mid-state opening 112A 112B) that produce a first state of the differently-sized open states. A second inner curvature may produce a second state (an open state aperture size) of the differently-sized open states. In the illustrated embodiment, a portion of the second inner curvature is interrupted by the first inner curvature. In the illustrated embodiment, the two blades have a blade width that produces, when in at least partial overlap with the other blade, the fully shuttered state (FIG. 2C).

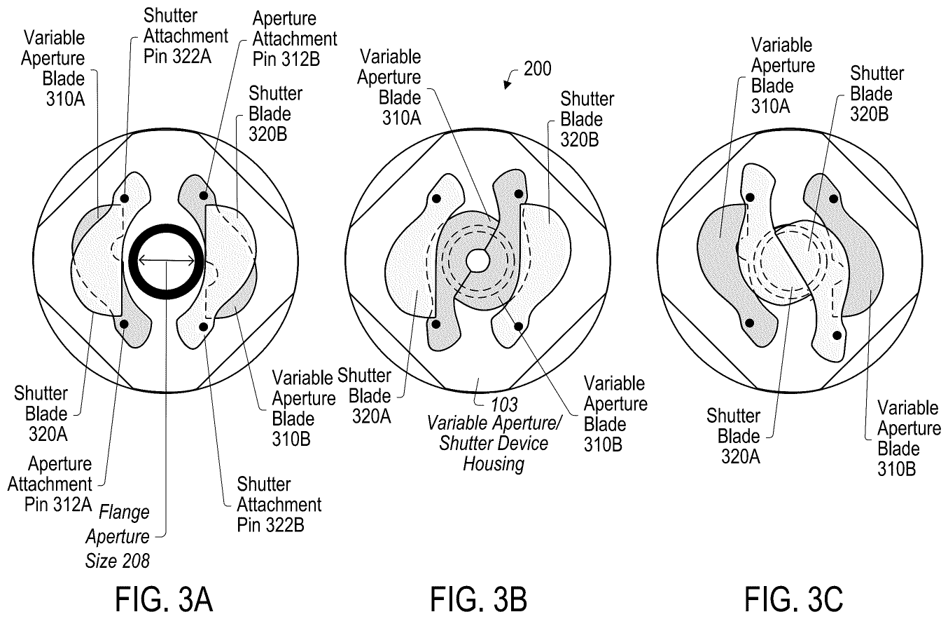

FIGS. 3A-3C illustrate views of various states (open, mid, shutter) of an example de-coupled variable aperture and shutter device 200 that may be included in a camera system, in accordance with some embodiments. FIGS. 3A-3C illustrates various states of a variable aperture mechanism for a camera, that includes two sets of blades, to be actuated by one or more actuators configured to move the two sets of blades to vary the aperture for the camera between the three illustrated states of the two sets of blades. The three states including at least two differently-sized open states (e.g., an open state illustrated in FIG. 3A, and a mid state illustrated in FIG. 3B) and a fully shuttered state (e.g., shutter state illustrated in FG. 3C). The two sets of blades are shaped to move between the three states with two levels of blades overlapping one another.

In FIGS. 3A-3C functionality associated with a variable aperture size is associated with aperture blade set 310A and 310B while the shutter functionality is associated with shutter blade set 320A and 320B (a “decoupled” architecture). In FIG. 3A, flange aperture size 208 is illustrated and formed by a component (a camera lens aperture, or the like) other than the blades (variable aperture blades 310A and 310B and shutter blades 320A and 320B). As in FIG. 1B the flange aperture size 208 may dictated by the flange 114 of a cover that covers the blades or by some other component (e.g., a camera lens aperture, or the like) when the blades are retracted as illustrated in FIG. 3A.

In FIG. 3A variable aperture blades 310A and 310B are pinned (or otherwise attached or coupled) to variable aperture/shutter device housing 102 via shutter attachment pins 322A and 322B. The pins affix the variable aperture blades to the variable aperture/shutter device housing 103 while allowing the blades to rotate or sweep over a fixed range of motion illustrated in FIGS. 3A-3C. Shutter blades 320A and 320B are affixed to variable aperture shutter device housing 103 via shutter attachment pins 322A and 322B while allowing the blades to rotate or sweep over a fixed range of motion illustrated in FIGS. 3A-3C. FIG. 3A illustrates the two sets of blades (the aperture blade set and the shutter blade set) in retracted positions. It is contemplated that each set of blades may be actuated by respective actuators, or that both sets of blades may be actuated by a single, shared actuator, or that each individual blade may be actuated by its own respective actuator, in various non-limiting example embodiments.

FIG. 3B illustrates variable aperture blades 310A 310B in an actuated or closed position (compared to the open, retracted position in FIG. 3A). FIG. 3B illustrates than when the variable aperture blades 310a 310B are actuated and rotate on their pins to meet together they form a smaller aperture than the aperture in FIG. 3A, while shutter blades 320A 320B remain retracted. Dotted lines forming circles in the center of FIG. 3B illustrate that the aperture blades have covered the aperture 106 formed by flange 208, forming the smaller opening.

FIG. 3C illustrates that variable aperture blades 310A 310B remain retracted while shutter blades 320A 320B have swung closed over aperture 106 putting the de-coupled variable aperture and shutter device 200 into a shutter state, blocking light from reaching an image sensor, in embodiments. In some embodiments, both of the shutter blades and the variable aperture blades may actuate at once, forming a shuttered state.

It is contemplated that some embodiments may include one or more additional variable aperture blade sets (e.g., each blade set having different size cutouts for forming different size aperture stops) in addition to those illustrated, adding additional aperture size options (additional aperture states), without departing from the scope of the disclosure

FIGS. 4A-4B illustrate views of individual components of a combined variable aperture and shutter device, in accordance with some embodiments. FIG. 4A illustrates an unobstructed view of the rotor 120/stator 130 of actuator assembly 410. FIG. 4B illustrates blades 110A 110B with trimmed edges 412A 412B (e.g., trimmed to avoid moving beyond a circumference that could contact or interfere with other components of the camera as the blades are rotated by an actuator).

In embodiments, the trimmed edges 412A 421B meet an outside circumference edge of the blades 110A 110B at an angle greater than 90 degrees and meet an inside interface edge 430A 430B at an angle greater than 90 degrees.

FIG. 4B illustrates that the rotor attachment point distance 422 (a distance between the rotor attachment pin and the trimmed edge of the blade 110A) is smaller than the stator attachment point distance 424 (a distance between the stator attachment pin and the trimmed edge of the blade 110A). It is contemplated that rotor attachment point distance 422 can be larger than the stator attachment point distance 424, in various embodiments (not illustrated) without departing from the scope of this disclosure.

FIGS. 5A-5C illustrate views of individual components of blades of a de-coupled variable aperture and shutter device, in accordance with some embodiments. FIG. 5A illustrates variable aperture blade 310A and corresponding aperture attachment pin 312A and variable aperture blade 310B and corresponding aperture attachment pin and that blade 310A and 310B may move in a swinging movement in relation to respective pins so as to come together to form a smaller aperture. FIG. 5B illustrates shutter blades 320A 320B with corresponding shutter attachment pins 322B and that blades 320A and 320B may move in a swinging movement in relation to respective pins so as to come together to form a shutter that prevents light from reaching an image sensor, in embodiments. FIG. 5C illustrates an embodiment of shutter blades 320A 320B that have a pattern shape 506 where the set of shutter blades meet (at interface 530). Blades of various shapes at the meeting point (interface 530) are contemplated, including but not limited to geometric shapes, curved shapes, symmetric or asymmetric shapes, etc.

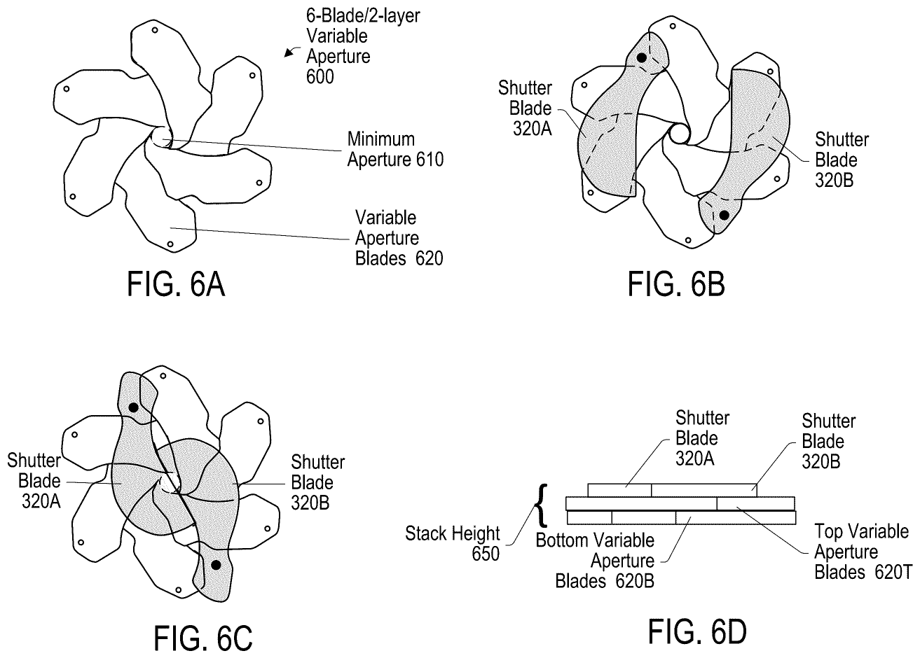

FIGS. 6A-6D illustrate views of states of an example combined variable aperture and shutter device that may be included in a camera system, in accordance with some embodiments. FIG. 6A illustrates a 2 layer, 6 blade layout (e.g., with 3 variable aperture blades 620 on top and 3 variable aperture blades 620 on bottom, all mounted with respective pins and operable via one or more actuators (e.g., to provide infinite aperture stop adjustability, in embodiments) that has a minimum aperture size 610. In such a design, the three blades of any given layer will interfere with one another as they move towards closing, and prevent full shutter-like closure (in contrast to a 6 layer, six blade layout that does not have such interference and can close fully for shutter functionality, but has a large Z stack up height due to the six layers). FIG. 6B illustrates that the 6-blade/2 layer variable aperture architecture illustrated in FIG. 6A may be combined with a set of shutter blades 320A 320B to achieve a shuttered state in addition to the variable aperture states possible with the device in FIG. 6A. FIG. 6B illustrates the shutter blades 320A 320B in an open or retracted state. FIG. 6C illustrates the shutter blades 320A 320B in a closed shutter state that prevents light from passing through the aperture formed by the variable aperture blades 620. FIG. 6D illustrates a stack height 650 of the combined variable aperture and shutter device 600, with three overlapping layers of blades: shutter blades 320A 320B, top variable aperture blades 620T and bottom variable aperture blades 620B.

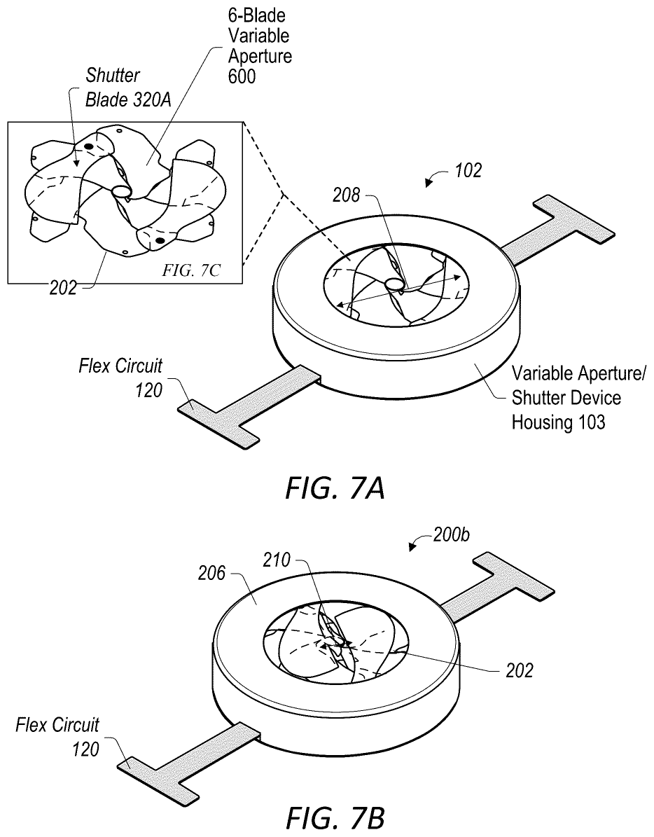

FIGS. 7A-7B illustrate views of the example combined variable aperture and shutter device in FIGS. 6B-6D within a variable aperture shutter device housing 103, in accordance with some embodiments (referred to as a combined variable aperture and shutter device for camera(s) 200 herein). In the illustrated embodiment, variable aperture/shutter device housing 103 houses the 6-blade/2 layer variable aperture architecture combined with shutter blades 320A 320B illustrated in FIGS. 6B-6D. The device is illustrated with a flex circuit 120 to route power and/or signals, for example. FIG. 7A illustrates the aperture blades in a minimum aperture configuration with the shutter blades retracted. FIG. 7B illustrates the aperture blades in a minimum aperture configuration with the shutter blades actuated in the shuttered state to prevent all light from reaching an image sensor, for example.

FIG. 8 illustrates a schematic representation of an example environment comprising a device 800 that may include one or more cameras. In various examples, the device 800 may include a camera with a combined variable aperture and shutter device, e.g., as described herein with reference to FIGS. 1-12. In some embodiments, the device 800 may be a mobile device and/or a multifunction device. In various embodiments, the device 800 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 800 may include a display system 802 (e.g., comprising a display and/or a touch-sensitive surface) and/or one or more cameras 804. In some non-limiting embodiments, the display system 802 and/or one or more front-facing cameras 804a may be provided at a front side of the device 800, e.g., as indicated in FIG. 8. Additionally, or alternatively, one or more rear-facing cameras 804b may be provided at a rear side of the device 800. In some embodiments comprising multiple cameras 804, some or all of the cameras 804 may be the same as, or similar to, each other. Additionally, or alternatively, some or all of the cameras 804 may be different from each other. In various embodiments, the location(s) and/or arrangement(s) of the camera(s) 804 may be different than those indicated in FIG. 8.

Among other things, the device 800 may include memory 806 (e.g., comprising an operating system 808 and/or application(s)/program instructions 810), one or more processors and/or controllers 812 (e.g., comprising CPU(s), memory controller(s), display controller(s), and/or camera controller(s), etc.), and/or one or more sensors 814 (e.g., orientation sensor(s), proximity sensor(s), and/or position sensor(s), etc.). In some embodiments, the device 800 may communicate with one or more other devices and/or services, such as computing device(s) 816, cloud service(s) 818, etc., via one or more networks 820. For example, the device 800 may include a network interface (e.g., network interface 910 in FIG. 9) that enables the device 800 to transmit data to, and receive data from, the network(s) 820. Additionally, or alternatively, the device 800 may be capable of communicating with other devices via wireless communication using any of a variety of communications standards, protocols, and/or technologies.

FIG. 9 illustrates a schematic block diagram of an example environment comprising a computer system 900 that may include a camera with a combined variable aperture and shutter device, e.g., as described herein with reference to FIGS. 1-8. In addition, computer system 900 may implement methods for controlling operations of the camera and/or for performing image processing on images captured with the camera. In some embodiments, the device 800 (described herein with reference to FIG. 8) may additionally, or alternatively, include some or all of the functional components of the described herein.

The computer system 900 may be configured to execute any or all of the embodiments described above. In different embodiments, computer system 900 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 900 includes one or more processors 902 coupled to a system memory 904 via an input/output (I/O) interface 906. Computer system 900 further includes one or more cameras 908 coupled to the I/O interface 906. Computer system 900 further includes a network interface 910 coupled to I/O interface 906, and one or more input/output devices 912, such as cursor control device 914, keyboard 916, and display(s) 918. In some cases, it is contemplated that embodiments may be implemented using a single instance of computer system 900, while in other embodiments multiple such systems, or multiple nodes making up computer system 900, may be configured to host different portions or instances of embodiments. For example, in one embodiment some elements may be implemented via one or more nodes of computer system 900 that are distinct from those nodes implementing other elements.

In various embodiments, computer system 900 may be a uniprocessor system including one processor 902, or a multiprocessor system including several processors 902 (e.g., two, four, eight, or another suitable number). Processors 902 may be any suitable processor capable of executing instructions. For example, in various embodiments processors 902 may be general-purpose or embedded processors implementing any of a variety of instruction set architectures (ISAs), such as the x86, PowerPC, SPARC, or MIPS ISAs, or any other suitable ISA. In multiprocessor systems, each of processors 902 may commonly, but not necessarily, implement the same ISA.

System memory 904 may be configured to store program instructions 920 accessible by processor 902. In various embodiments, system memory 904 may be implemented using any suitable memory technology, such as static random access memory (SRAM), synchronous dynamic RAM (SDRAM), nonvolatile/Flash-type memory, or any other type of memory. Additionally, existing camera control data 922 of memory 904 may include any of the information or data structures described above. In some embodiments, program instructions 920 and/or data 922 may be received, sent, or stored upon different types of computer-accessible media or on similar media separate from system memory 904 or computer system 900. In various embodiments, some or all of the functionality described herein may be implemented via such a computer system 900.

In one embodiment, I/O interface 906 may be configured to coordinate I/O traffic between processor 902, system memory 904, and any peripheral devices in the device, including network interface 910 or other peripheral interfaces, such as input/output devices 912. In some embodiments, I/O interface 906 may perform any necessary protocol, timing, or other data transformations to convert data signals from one component (e.g., system memory 904) into a format suitable for use by another component (e.g., processor 902). In some embodiments, I/O interface 906 may include support for devices attached through various types of peripheral buses, such as a variant of the Peripheral Component Interconnect (PCI) bus standard or the Universal Serial Bus (USB) standard, for example. In some embodiments, the function of I/O interface 906 may be split into two or more separate components, such as a north bridge and a south bridge, for example. Also, in some embodiments some or all of the functionality of I/O interface 906, such as an interface to system memory 904, may be incorporated directly into processors 902.

Network interface 910 may be configured to allow data to be exchanged between computer system 900 and other devices attached to a network 924 (e.g., carrier or agent devices) or between nodes of computer system 900. Network 924 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 910 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output device(s) 912 may, in some embodiments, include one or more display terminals, keyboards, keypads, touchpads, scanning devices, voice or optical recognition devices, or any other devices suitable for entering or accessing data by one or more computer systems 900. Multiple input/output devices 912 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 910.

Those skilled in the art will appreciate that computer system 900 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending, or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A variable aperture mechanism for a camera, comprising:
one or more sets of blades; and
one or more actuators configured to move the one or more sets of blades to vary an aperture for the camera between at least three states of the one or more sets of blades, the three states including at least two differently-sized open aperture states and a fully shuttered state;
wherein the one or more sets of blades are shaped to move between the at least three states with no more than three levels of overlap of the one or more sets of blades.

2. The variable aperture mechanism for a camera of claim 1, wherein:
the one or more sets of blades comprise no more than a single set of two blades; and
each individual one of single set of two blades comprises:
a first inner curvature configured to produce a first state of the differently-sized open states;
a second inner curvature configured to produce a second state of the differently-sized open states, a portion of the second inner curvature interrupted by the first inner curvature; and
a blade width configured to produce, when in at least partial overlap with the other blade, the fully shuttered state.

3. The variable aperture mechanism for a camera of claim 2, further comprising:
a rotor; and
a stator;
wherein each individual one of the single set of two blades is coupled to:
the rotor via a rotor pivot; and
the stator via a stator pivot.

4. The variable aperture mechanism for a camera of claim 3, wherein one or more of the actuators are configured to rotate the single set of two blades via the rotor and stator in order to move the single set of two blades to vary the aperture for the camera.

5. The variable aperture mechanism for a camera of claim 3, wherein the single set of two blades comprise trimmed edges to avoid travel outside a circumference of the rotor as the set of blades rotate through the states.

6. The variable aperture mechanism for a camera of claim 1, wherein a diameter of an aperture for the camera in a fully open state of the at least two differently-sized open aperture states is not determined by any of the blades.

7. The variable aperture mechanism for a camera of claim 1, wherein the one or more sets of blades comprise:
a first set of the sets of blades configured to vary the aperture for the camera between the two differently-sized open states; and
a second set of the sets of blades configured to put the aperture into the fully shuttered state.

8. The variable aperture mechanism for a camera of claim 1, wherein the one or more sets of blades comprise:
a first set of variable aperture blades configured to provide three or more differently-sized open states; and
a second set of shutter blades configured to provide the fully shuttered state.

9. The variable aperture mechanism for a camera of claim 8, wherein the one or more actuators comprise at least two actuators configured to move the first set of variable aperture blades and the second set of shutter blades independently.

10. A lens assembly for a camera, comprising:
a lens group comprising one or more lens elements that define an optical axis; and
a variable aperture mechanism configured control light entering into the lens group, comprising:
one or more sets of blades;
one or more actuators configured to move the one or more sets of blades to vary an aperture for the camera between at least three states of the one or more sets of blades, the three states including at least two differently-sized open states and a fully shuttered state;
wherein the one or more sets of blades are shaped to move between the at least three states with no more than three levels of overlap of the one or more sets of blades.

11. The lens assembly for a camera of claim 10, wherein:
the one or more sets of blades comprise no more than a single set of two blades; and
each individual blade of the single set of two blades comprises:
a first inner curvature configured to produce a first state of the differently-sized open states;
a second inner curvature configured to produce a second state of the differently-sized open states, a portion of the second inner curvature interrupted by the first inner curvature; and
a blade width configured to produce, when in at least partial overlap with the other blade, the fully shuttered state.

12. The lens assembly for a camera of claim 11, further comprising:
a rotor; and
a stator;
wherein each individual one of the single set of two blades is coupled to:
the rotor via a rotor pivot; and
the stator via a stator pivot.

13. The lens assembly for a camera of claim 12, wherein one or more of the actuators are configured to rotate the single set of two blades via the rotor and stator in order to move the single set of two blades to vary the aperture for the camera.

14. The lens assembly for a camera of claim 12, wherein the single set of two blades comprise trimmed edges to avoid travel outside a circumference of the rotor as the set of blades rotate through the states.

15. The lens assembly for a camera of claim 10, wherein a diameter of an aperture for a fully open state of the at least two differently-sized open aperture states is not determined by any of the blades.

16. The lens assembly for a camera of claim 10, wherein the one or more sets of blades comprise:
a first set of the sets of blades configured to vary the aperture for the camera between the two differently-sized open states; and
a second set of the sets of blades configured to put the aperture into the fully shuttered state.

17. The lens assembly for a camera of claim 10, wherein the one or more sets of blades comprise:
a first set of variable aperture blades configured to provide three or more differently-sized open states; and
a second set of shutter blades configured to provide the fully shuttered state.

18. The lens assembly for a camera of claim 10, wherein the one or more sets of blades comprise:
a set of blades configured to meet one another at a blade interface in a closed position;
wherein the blade interface is a non-linear shape.

19. A device, comprising:
one or more processors;
memory storing program instructions executable by the one or more processors to control operations of a camera; and
the camera, comprising:
a lens group comprising one or more lens elements that define an optical axis; and
a variable aperture mechanism for a camera, comprising:
one or more sets of blades; and
one or more actuators configured to move the one or more sets of blades to vary an aperture for the camera between at least three states of the one or more sets of blades, the three states including at least two differently-sized open states and a fully shuttered state;
wherein the one or more sets of blades are shaped to move between the at least three states with no more than three levels of overlap of the one or more sets of blades.

20. The device of claim 19, wherein:
the one or more sets of blades comprise no more than a single set of two blades; and
each individual blade of the single set of two blades comprises:
a first inner curvature configured to produce a first state of the differently-sized open states;
a second inner curvature configured to produce a second state of the differently-sized open states, a portion of the second inner curvature interrupted by the first inner curvature; and
a blade width configured to produce, when in at least partial overlap with the other blade, the fully shuttered state.
